(19) United States
(12) Patent Application Publication
(10) Pub. No.: US 2020/0366150 A1
(43) Pub. Date: Nov. 19, 2020

(54) POTTING UHV INSULATION SYSTEM

(71) Applicant: Hanon Systems, Daejeon (KR)

(72) Inventors: David Walisko, Hürth (DE); Frank Mau, Aachen (DE); Marco Hombitzer, Aachen (DE)

(21) Appl. No.: 16/858,825

(22) Filed: Apr. 27, 2020

(30) Foreign Application Priority Data
May 14, 2019 (DE) 102019112551.0

(51) Int. Cl. H02K 3/44; H02K 3/24; H02K 3/32; H02K 15/10; H02K 15/12; F25B 31/02

(52) U.S. Cl. CPC H02K 3/44; H02K 3/24; F25B 31/026; H02K 15/105; H02K 15/12; H02K 3/325

(57) ABSTRACT

An electric motor for driving a hermetic compressor, wherein the stator comprises a stator core, which has bars, directed radially inward, and which are arranged evenly distributed about a circumference, on an inner side of the stator, which is substantially cylindrically shaped outward, wherein stator slots are formed between the bars, which are respectively adjacent in the circumferential direction, and wherein conducting wires are respectively wound into coils around the bars, and wherein each intermediate space between individual wires of a winding, between each winding and a base insulation, which is situated between the winding and the stator core, between the different coils, and between each winding and non-current-conducting housing parts and/or attachment parts of the stator, is filled with a potting compound as the insulating material, and wherein recesses for cooling ducts to cool the stator are formed within the insulating material.

### CROSS-REFERENCE TO RELATED PATENT APPLICATION

The present disclosure claims the benefit of German Patent Application No. DE 10 2019 112 551.0 filed May 14, 2019, the entire contents of which are hereby incorporated herein by reference.

### FIELD

The invention relates to a stator of an electric motor for driving a hermetic compressor. Moreover, the invention relates to a method for producing a stator insulation system for a corresponding electric motor.

### BACKGROUND

Due to a high voltage range of up to 1000 V, the requirements are extraordinarily high regarding insulation coordination in electric compressors. Such requirements regarding insulation coordination particularly relate to the so-called air gap as the shortest distance in air between two conductive parts as well as the so-called creepage distance as the shortest distance along the surface of an insulating material between these two conductive parts. International standards such as the independent Underwriters Laboratories (UL), which tests and certifies products regarding safety, and the International Electrotechnical Commission (IEC) require, for example for a voltage range of up to 1000 V, that the creepage distance is 14 mm (IEC) and the air gap is 10 mm (UL). Similar requirements are contained in national standards like the Deutsches Institut für Normung (DIN, German Institute of Standardization) for example.

For previously known EHV electric motors (˜400 V), the smallest air gap between two coils is about 4 mm and the shortest creepage distances are about 5 mm. For the automotive industry, the insulation system of hermetically sealed electric motors, which are suitable for air conditioning systems, represents a major challenge in light of an ultra-high voltage (UHV) of up to 1000 V for example, particularly in application cases with voltage ranges beyond this.

### SUMMARY

The object of the invention is the provision of a stator, which enables the complete adherence to existing requirements for insulation coordination, at various voltage levels, and simultaneously enables the smallest possible dimensions. Furthermore, sufficient cooling of the stator should also be ensured.

This object is achieved by means of a stator as disclosed herein.

The stator according to the invention comprises a stator core, which has bars, directed radially inward, and which are arranged evenly distributed about the circumference, on the inner side of the stator, which is substantially cylindrically shaped outward, wherein stator slots are formed between bars, which are respectively adjacent in the circumferential direction. In this case, conducting wires are respectively wound into coils around the bars. According to the invention, each intermediate space between the individual wires of a winding, between each winding and a base insulation, which is situated between the winding and the stator core, between the different coils, and between each winding and non-current-conducting housing parts and/or attachment parts of the stator, for example covers, is filled with a potting compound as the insulating material, wherein, however, recesses for cooling ducts to cool the stator are formed within the insulating material. The insulating material may be a resin, preferably an epoxy resin, but also any other suitable binding agent or any other suitable adhesive.

According to the concept of the invention, complete potting of the stator insulation system is designed and dimensioned in order to fulfill all requirements placed on insulation coordination, according to known standards such as the IEC, UL, and DIN. In this case, the filling of any open space with insulating material, for example a resin, takes place between the individual wires of a winding, the different phases and/or coils, and between the winding and housing parts (ground). Through use of the aforementioned potting and the additional use of suitable potting material, functional insulation of the current-conducting parts is ensured.

Furthermore, the creepage paths between the adjacent parts are extended and/or interrupted and the propagation of creepage currents is suppressed through the use of the single-part potting and the further use of suitable potting material. Thus, the requirements from the known standards with respect to installation coordination in compliance with IEC, UL, and DIN are also fulfilled in hermetic compressors.

In order to ensure, moreover, sufficient cooling of the stator, recesses, through which refrigerant flows during operation of the compressor, are provided during casting of the stator in order to dissipate the developing heat.

According to an advantageous embodiment of the invention, the recesses are formed in the stator slots within the insulating material. The variant in which a recess is formed in each stator slot is especially preferred in this case. Preferably, the recesses are formed as elongated ducts for the flow of refrigerant, the longitudinal sides of said recesses extending from a first end face of the stator to an oppositely positioned second end face of the stator. The recesses are preferably radially aligned in the cross-section of the stator.

A further aspect of the present invention relates to a method for producing a stator insulation system, particularly of an electric motor for driving a hermetic compressor, by means of potting of the stator with an insulating material, comprising the following steps:
a₁) Inserting a first, inner mold into a stator core formed substantially cylindrically outward, which has bars, directed radially inward, and which are arranged evenly distributed about the circumference, on the inner side of the stator core, wherein stator slots are formed between bars, which are respectively adjacent in the circumferential direction, and wherein conducting wires are respectively wound into coils around the bars, and wherein the mold is formed such that it covers the area for the rotor, the area for the air gap between the stator and rotor of the electric motor, as well as the space for cooling ducts,
a₂) Encapsulating the stator core with a second, outer mold, or inserting the stator core into said mold in order to limit the contour of the potting radially outward in the area of the coil winding sections situated outside of the stator slots as well as the contour of the potting in the axial direction,
b) Filling any open space between the individual wires of a winding, between each winding and a base insulation, which is situated between the winding and the stator core, between the different coils, and between each winding and housing parts and/or attachment parts of the stator, with a potting compound as the insulating material, and
c) Removing the molds from the potted stator.

Steps a₁) and a₂) in this case can occur in any sequence or even simultaneously, particularly simultaneously when the inner and the outer mold are connected to one another or both molds are formed in an overall mold as mold components. According to one embodiment for an inner mold, with which a completely potted stator insulation system can be produced for hermetic electric compressors, the inner mold has a middle part with linear bar-like protrusions being arranged distributed about the circumference.

In this case, the middle part not only can cover the space required for the rotor but also the space for the air gap between the stator and rotor as relates to filling with insulating material, while the linear bar-like protrusions distributed in this arrangement are suitable for keeping the spaces within the stator slots free for the cooling ducts. Preferably, the bar-like protrusions are distributed and aligned such that only one linear bar-like protrusion protrudes into a stator slot in order to cover the respective space for a corresponding recess.

The linear bar-like protrusions are aligned radially outward and extend over the entire length of the middle part in the axial direction.

By using such a mold, it can be ensured that the space necessary for cooling ducts within the stator slots, for the air gap of the electric motor, as well as for the rotor remain free of potting compound. A resin, preferably an epoxy resin, but also any other suitable binding agent, can be used as the potting compound.

The present stator insulation system enables complete adherence to the existing specifications and general requirements for electric motors in electric air conditioning compressors for motor vehicles with various voltage levels.

Further details, features, and advantages of embodiments of the invention result from the following description of exemplary embodiments with reference to the corresponding figures.

### BRIEF DESCRIPTION OF THE DRAWINGS

The following is shown:

FIG. 1: a stator core together with molds for insulating a stator,

FIG. 2: the stator after the potting process upon removal of a mold,

FIG. 3: a view of the stator after potting showing a view of the end face facing an inverter,

FIG. 4: a view of the stator after potting showing a view of the end face facing the compressor unit,

FIG. 5: a detailed partial view of two adjacent stator slots with the mold inserted before potting, and

FIG. 6: a detailed partial view of a section through a potted stator slot after removal of the mold.

### DETAILED DESCRIPTION OF AN EMBODIMENT

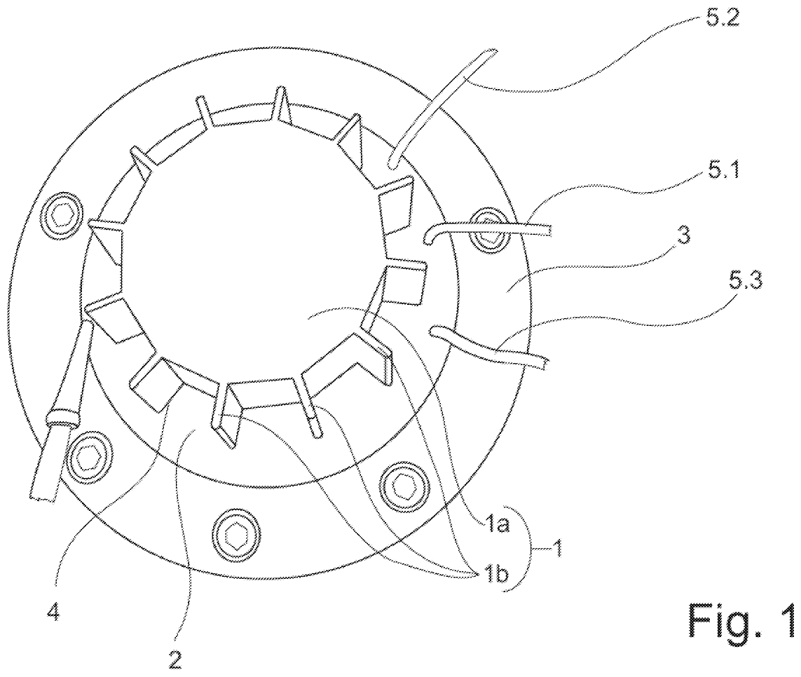

FIG. 1 shows an example of a first, inner mold 1 for the potting of potting compound for insulating the stator. By means of this mold 1, a completely potted stator insulation system can be produced for hermetic electric compressors. The mold 1 has a middle part 1a with linear bar-like protrusions 1b arranged distributed around the circumference thereof, said protrusions extending radially outward. The liner bar-like protrusions 1b in this case have their greatest expansion along the longitudinal sides. The expansion of the transverse sides of each of the protrusions 1b is less than that of the longitudinal sides and greater than the thickness of the protrusion 1b. The longitudinal sides of the protrusions 1b are aligned axially with respect to the cylinder axis of the stator and extend over the entire axial length of the middle part 1a. The transverse sides determine the length of the protrusions 1b outward, i.e. in the radial direction.

FIG. 1 shows how the inner mold 1 is inserted into the middle of a stator core, wherein the potting with insulating material 2 has already taken place in this view, and the stator core is covered by the inner mold, by the insulating material 2, and by a second, outer mold 3, which is provided next to the first, inner mold 1, and thus the stator core is not visible. In this case, the middle part 1a of the mold 1 is dimensioned such that it covers the area provided for the rotor and also the area for the air gap between the stator and rotor. Moreover, the linear bar-like protrusions 1b protrude, in the radial direction, into the stator slots 4 formed in the stator core, said slots forming the intermediate spaces between bars, which are also not shown, of the stator core. With such a mold 1, it is ensured that, with the complete potting according to the invention with the insulating material 2, not only the space required for the rotor but also the space for the cooling ducts within the stator slots 4 formed in the stator core remain free.

A conducting wire of one of the three electrical lines 5.1; 5.2; 5.3 (phases) visible in FIG. 1 is wound into a coil around each of the elongated bars of the stator core, in the axial direction. The winding heads, i.e. the end-face sections of the coils which are situated outside of the stator slots 4, above or below the bars, are located in the area of the end faces of the stator. The outer mold 3 is necessary in order to design the contour of the potting with insulating material 2 in the area of these winding heads as well. The outer mold 3 encapsulates the stator core and limits the contour of the potting radially outward in the area of the winding heads as well as the contour of the potting in the axial direction of the stator core. As previously mentioned, potting of the insulating material 2 has already occurred in the view from FIG. 1 and said potting thus covers the winding heads of the coils, which are thus no longer visible.

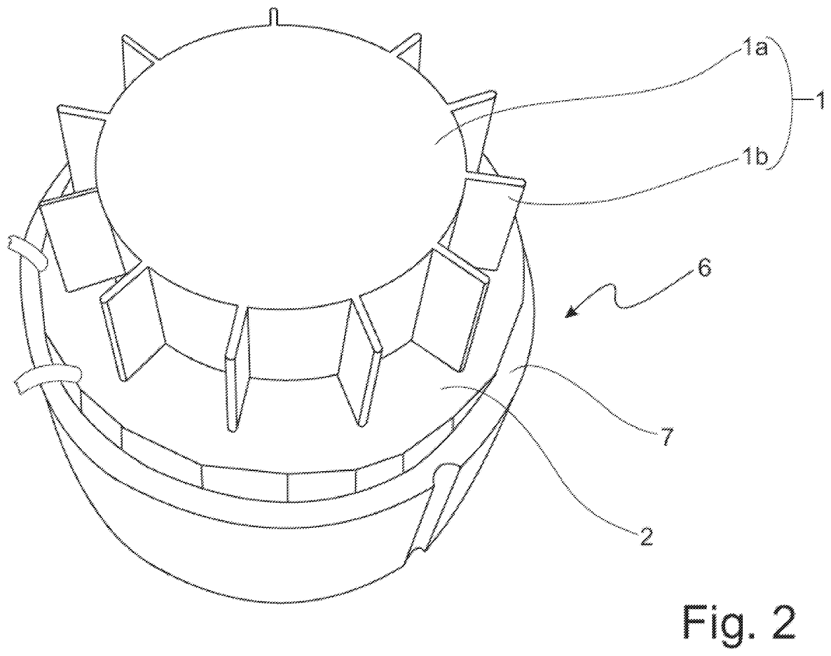

FIG. 2 correspondingly shows the insulated stator 6 after removal of the outer mold 3 when the inner mold 1 is lifted out after potting. Any open spaces remaining outside of the mold 1 are filled with insulating material 2, the open spaces being situated between the individual wires of the winding of a coil, between the different conducting wires and/or the coils wound therefrom, which are also characterized as phases, as well as between each winding and non-current-conducting housing parts of the stator 6, which are also characterized as the ground. As is shown in FIG. 2, the potting with insulating material 2 is longer axially than the stator core 7 so that the winding heads are also potted.

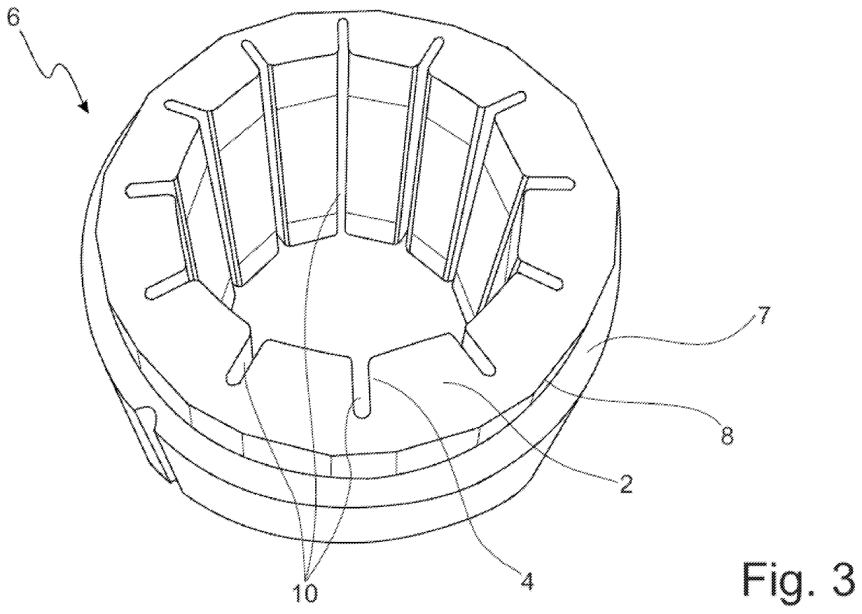

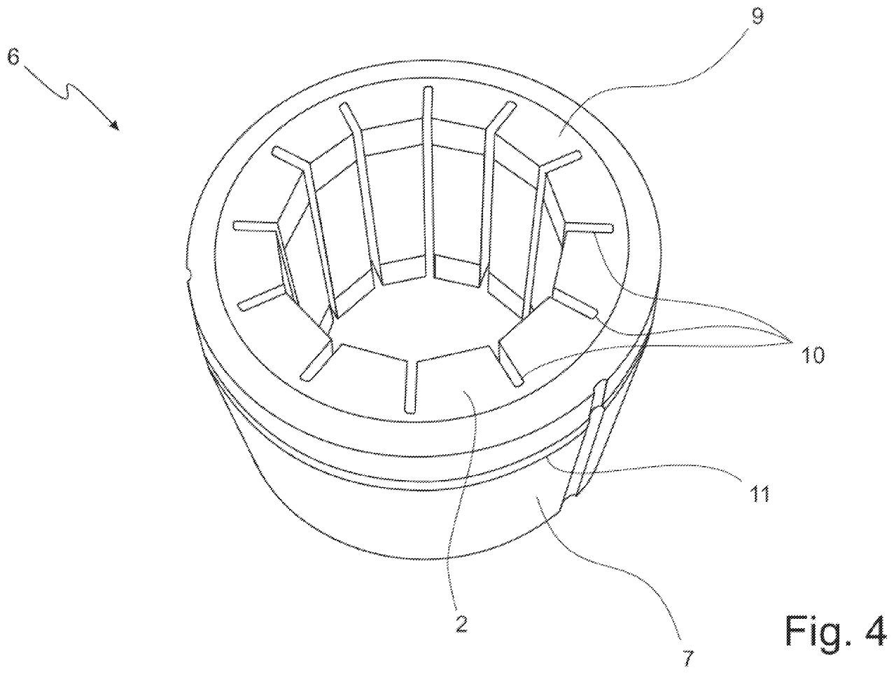

FIG. 3 shows a view of the stator 6 after potting and removal of the mold, showing a view of a first end face 8 facing an inverter of a compressor, while FIG. 4 shows a view of the stator 6 after potting and removal of the mold, showing a view of the second end face 9 oppositely disposed facing the compressor unit. As the insulating material 2, the potting compound forms a solid composite with the windings of the coils, which are no longer visible in FIGS. 3 and 4 due to the covering by the insulating material 2, and forms a composite with the stator core 7. Linear, radially aligned recesses 10 are formed in the areas in the stator slots 4, which were previously occupied by the linear bar-like protrusions 1b of the mold 1 (cf. FIGS. 1 and 2). These recesses 10 extend, in the axial direction, from the first end face 8 of the stator 6 to the oppositely disposed second end face 9 of the stator 6 and are provided for coolant to flow through them during operation of the compressor in order to dissipate the resulting heat and to ensure sufficient cooling of the stator 6. As is also shown in FIG. 3, the potting with insulating material 2 is longer axially than the stator core 7 itself. As shown by example in FIG. 4, the outer diameter of the potting in the area of the winding heads may deviate from the inner diameter of the stator yoke 11, the cylindrical part of the stator core 7. In the example shown, the outer diameter of the potting is greater than the inner diameter.

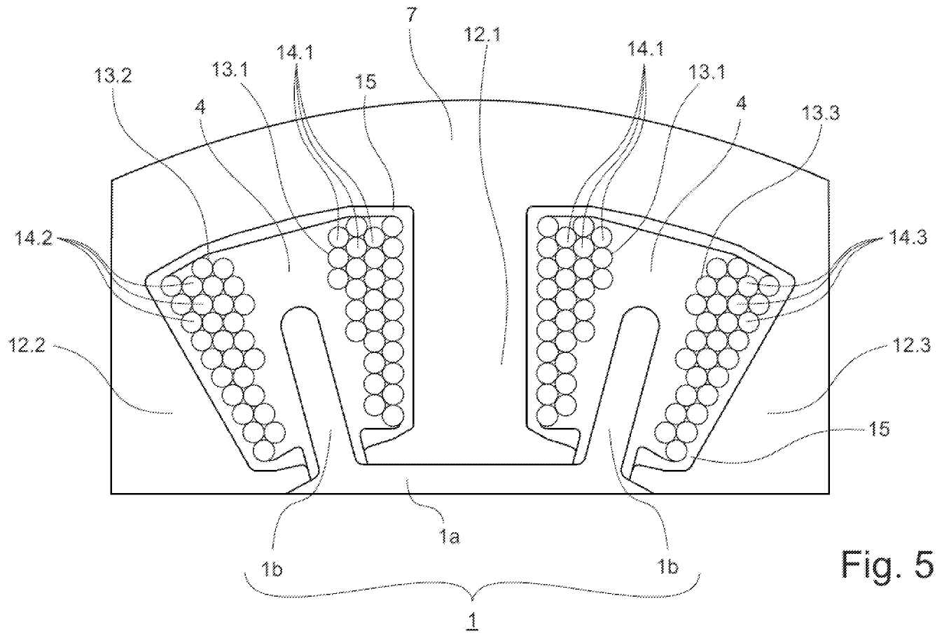

FIG. 5 shows a cross-section of a bar 12.1 of the stator core 7, as well as a part of its two adjacent bars 12.2, 12.3 in the circumferential direction of the stator on both sides. In the winding technology shown by example in this case, conducting wires are wound into coils 13.1, 13.2, 13.3 about the bars 12.1, 12.2, 12.3, wherein each coil 13.1; 13.2; 13.3 is shown as a cross-section of a plurality of individual wires 14.1; 14.2; 14.3 of the respective winding. The individual wires 14.1; 14.2; 14.3 of a winding within the scope of the present invention are understood to be the sections of the conducting wire respectively wound into a coil 13.1; 13.2; 13.3, said sections appearing in the cross-section as individual wires 14.1; 14.2; 14.3. Base insulation 15 of the stator core 7 is provided between the windings of the coils and the stator core 7. FIG. 5 schematically shows the situation before potting of the insulating material into the stator slots 4 situated between the adjacent bars 12.1, 12.2, 12.3. The stator slots 4 are not yet filled; while the mold 1 with its middle part 1a and its bar-like protrusions 1b is already inserted into the areas which should remain free of potting compound. While the middle part 1a covers the space required for the rotor as well as the space for the air gap of insulating material between the stator and the rotor, the linear bar-like protrusions 1b distributed in the circumferential direction keep the spaces free for the cooling ducts within the stator slots 4. These areas are used to improve cooling of the motor and to ensure sufficient flow of the refrigerant through the motor. The bar-like protrusions 1b of the mold 1 are distributed and aligned such that only one linear bar-like protrusion 1b protrudes into a stator slot 4 in order to cover the respective space for a corresponding recess.

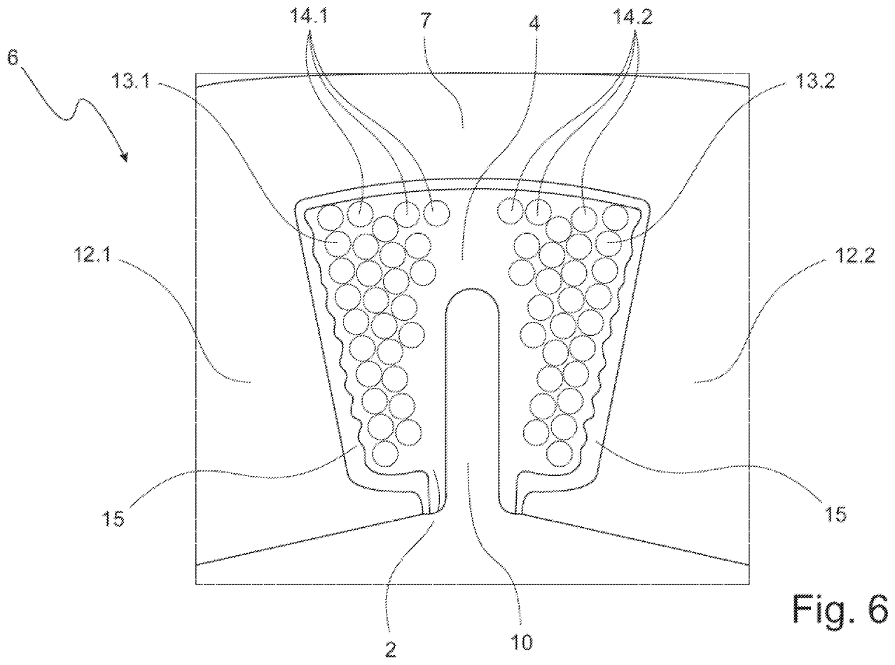

FIG. 6 shows a partial cross-section transversely with respect to the cylinder axis of the insulated stator 6, wherein said partial cross-section also comprises the cross-section of a potted stator slot 4. FIG. 6 particularly shows the spaces in the stator slot 4 filled with potting compound as the insulating material 2 as well as the recess 10 which is provided for coolant to flow. In addition, FIG. 6 shows a respective part of the two bars 12.1, 12.2 of the stator core 7, said bars being adjacent in the circumferential direction, as well as a respective part of the two different coils 13.1, 13.2, wherein each intermediate space between the respective individual wires 14.1; 14.2 of a winding, between each winding and the base insulation 15, between the different coils 13.1, 13.2, and between each winding and non-current-conducting housing parts of the stator 6 and/or attachment parts, for example covers, is filled with insulating material 2. In this manner, not only is each stator slot 4 in the stator core 7 filled with insulating material 2—with the exception of the areas of the recess 10 previously kept free—but also the winding heads situated in the areas of the end faces of the stator 6 are completely potted. The creepage paths between the adjacent coils 13.1, 13.2 are interrupted and the propagation of creepage currents is suppressed through the use of the single-part potting and the use of suitable insulating material 2.

### LIST OF REFERENCE NUMERALS

1 First, inner mold
1a Middle part of the mold
1b Linear bar-like protrusions
2 Insulating material
3 Second, outer mold
4 Stator slot
5.1 Electrical line
5.2 Electrical line
5.3 Electrical line
6 (Insulated) stator
7 Stator core
8 First end face of the stator
9 Second end face of the stator
10 Recesses for cooling ducts
11 Stator yoke
12.1 Bar of the stator core
12.2 Bar of the stator core
12.3 Bar of the stator core
13.1 Coil
13.2 Coil
13.3 Coil
14.1 Individual wires of a winding
14.2 Individual wires of a winding
14.3 Individual wires of a winding
15 Base insulation

What is claimed is:

1. A stator of an electric motor for driving a hermetic compressor, wherein the stator comprises:
a stator core, which has bars directed radially inward arranged evenly distributed about a circumference of the stator core on an inner side of the stator which is substantially cylindrically shaped on an outward side, wherein stator slots are formed between the bars respectively adjacent in a circumferential direction, and wherein conducting wires are respectively wound into coils around the bars, and wherein each intermediate space between individual ones of the conducting wires of windings, between each of the windings and a base insulation which is situated between the windings and the stator core, between different ones of the coils, and between each of the windings and non-current-conducting housing parts and/or attachment parts of the stator, is filled with a potting compound as an insulating material, and wherein recesses for cooling ducts to cool the stator are formed within the insulating material.

2. The stator according to claim 1, wherein the insulating material is a resin.

3. The stator according to claim 2, wherein the insulating material is an epoxy resin.

4. The stator according to claim 1, wherein the recesses are formed within the insulating material in the stator slots.

5. The stator according to claim 4, wherein one of the recesses is formed in each of the stator slots.

6. The stator according to claim 1, wherein the recesses are formed as elongated ducts, a longitudinal side of each of the elongated ducts extends from a first end face of the stator to an oppositely situated second end face of the stator.

7. The stator according to claim 6, wherein the recesses are aligned radially in a cross-section of the stator.

8. A method for producing a stator insulation system, particularly for an electric motor for driving a hermetic compressor, by means of potting of a stator with an insulating material, comprising the following steps:
a₁) inserting a first inner mold into a stator core formed substantially cylindrically outward which has bars directed radially inward, and the bars are arranged evenly distributed about a circumference of the stator core on an inner side of the stator core, wherein stator slots are formed between each of the bars which are respectively adjacent in a circumferential direction, and wherein conducting wires are respectively wound into coils around the bars, and wherein the first inner mold is formed such that it covers an area for a rotor, an area for an air gap between the stator and the rotor of the electric motor, as well as a space for cooling ducts,
a₂) encapsulating the stator core with a second outer mold, or inserting the stator core into the second outer mold in order to limit a contour of the potting radially outward in an area of a coil winding section situated outside of the stator slots as well as the contour of the potting in an axial direction,
b) filling an open space between the individual ones of the conducting wires of windings, an open space between each of the windings and a base insulation which is situated between the windings and the stator core, an open space between different ones of the coils, and an open space between each of the windings and housing parts and/or attachment parts of the stator, respectively, with a potting compound as an insulating material, and
c) removing the first inner mold and the second outer mold from the stator.

9. The method according to claim 8, wherein the first inner mold has a middle part with linear bar-like protrusions arranged distributed around a circumference thereof, wherein the middle part covers the area for the rotor as well as the area for the air gap between the stator and rotor for insulating material, while the linear bar-like protrusions keep the space free for the cooling ducts within the stator slots.

10. The method according to claim 9, wherein the linear bar-like protrusions are aligned radially outward and extend, in the axial direction, over an entire length of the middle part.
